(19) United States
(12) Patent Application Publication
(10) Pub. No.: US 2016/0063379 A1
(43) Pub. Date: Mar. 3, 2016

(54) Anonymous Crowd Sourced Software Tuning

(71) Applicant: International Business Machines Corporation, Armonk, NY (US)

(72) Inventors: Darryl M. Adderly, Morrisville, NC (US); Ingo Averdunk, Poing (DE); Jonathan W. Jackson, Durham, NC (US); Ajit Jariwala, Cary, NC (US); Eric B. Libow, Raleigh, NC (US)

(21) Appl. No.: 14/475,714

(22) Filed: Sep. 3, 2014

(51) Int. Cl. G06N 5/04

(52) U.S. Cl. CPC G06N 5/04

(57) ABSTRACT

An approach is provided for providing anonymous crowd sourced software tuning. The approach operates by anonymously receiving usage data from a number of software customer systems. The usage data that is received pertains to a software product. The received usage data is analyzed to identify healthy system patterns. The usage data received from each customer system is compared to at least one of the healthy system patterns. In one embodiment, the usage data from a customer system is compared to healthy system patterns from systems with similar configurations as the customer system. Sets of recommendations are generated based on the comparison with each set of recommendations corresponds to one of the software customers. The generated recommendations are provided to the respective software customers.

### BACKGROUND

Currently, many software solutions expect customers to interpret configuration recommendations manually, and in most cases, do not take into account the entire solution or environment. There are some systems intelligent enough to make basic recommendations based on some general metrics, but they are isolated to a particular environment and are based on known, tested configurations. Some traditional approaches apply a set of canned solutions to identified performance problems. These traditional solutions flow in a single direction—from a well-defined set of performance fixes to applications. Another traditional approach uses software modules that profile the performance of one computer, collect the data, then adjust the modules, if necessary, based on detected patterns.

### SUMMARY

An approach is provided for providing anonymous crowd sourced software tuning. The approach operates by anonymously receiving usage data from a number of software customer systems. The usage data received pertains to a software product. The received usage data is analyzed to identify healthy system patterns. The usage data received from each customer system is compared to at least one of the healthy system patterns. In one embodiment, the usage data from a customer system is compared to healthy system patterns from systems with similar configurations as the customer system. Sets of recommendations are generated based on the comparison with each set of recommendations corresponding to one of the software customers. The generated recommendations are provided to the respective software customers.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a block diagram of a processor and components of an information handling system;

FIG. 2 is a network environment that includes various types of information handling systems interconnected via a computer network;

FIG. 3 is a component diagram depicting the various components used by a software vendor and its customers to implement anonymous crowd sourced software tuning;

FIG. 4 is a flowchart depicting the steps performed by the vendor and customers to anonymously report the customer's usage of software and anonymously receive recommendations to tune the customers' systems;

FIG. 5 is a depiction of a flowchart showing the logic performed to implement the anonymous sending of customer data to the software vendor and the customer anonymously retrieving recommendations based on customer's configuration;

FIG. 6 is a depiction of a flowchart showing steps taken by the vendor to identify healthy and unhealthy system patterns from data anonymously received from customer systems; and

FIG. 7 is a depiction of a flowchart showing the logic performed by the software vendor to generate specific configuration and tuning recommendations for customers and allow customers with anonymous retrieval mechanism.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

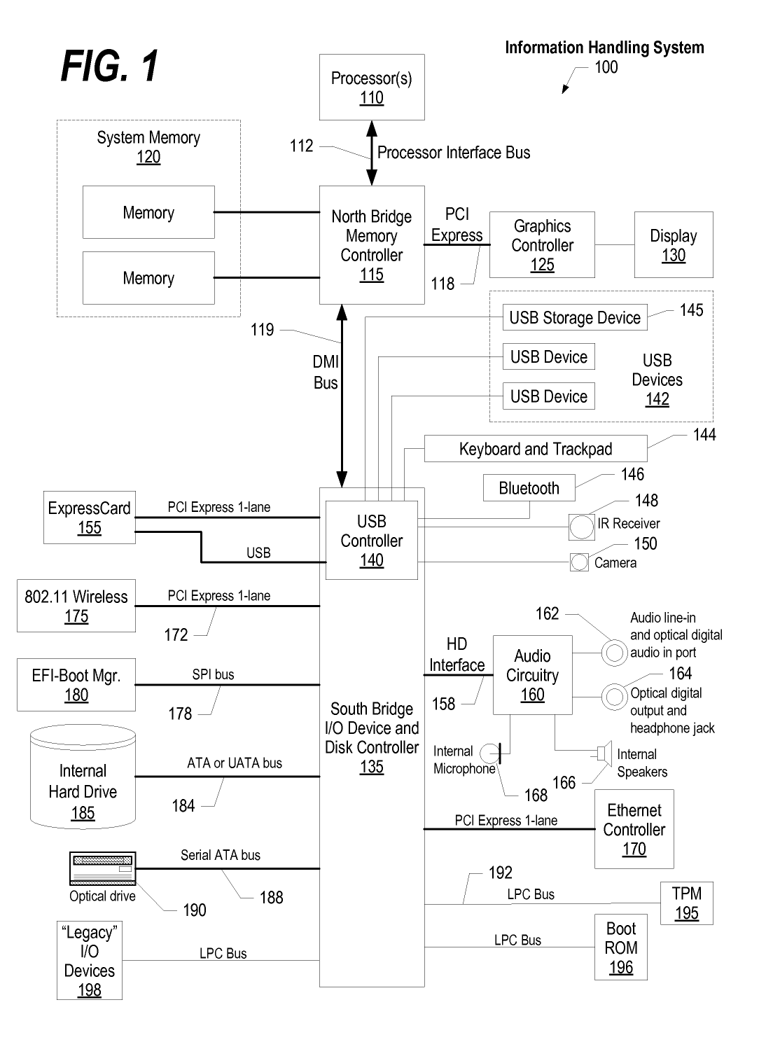

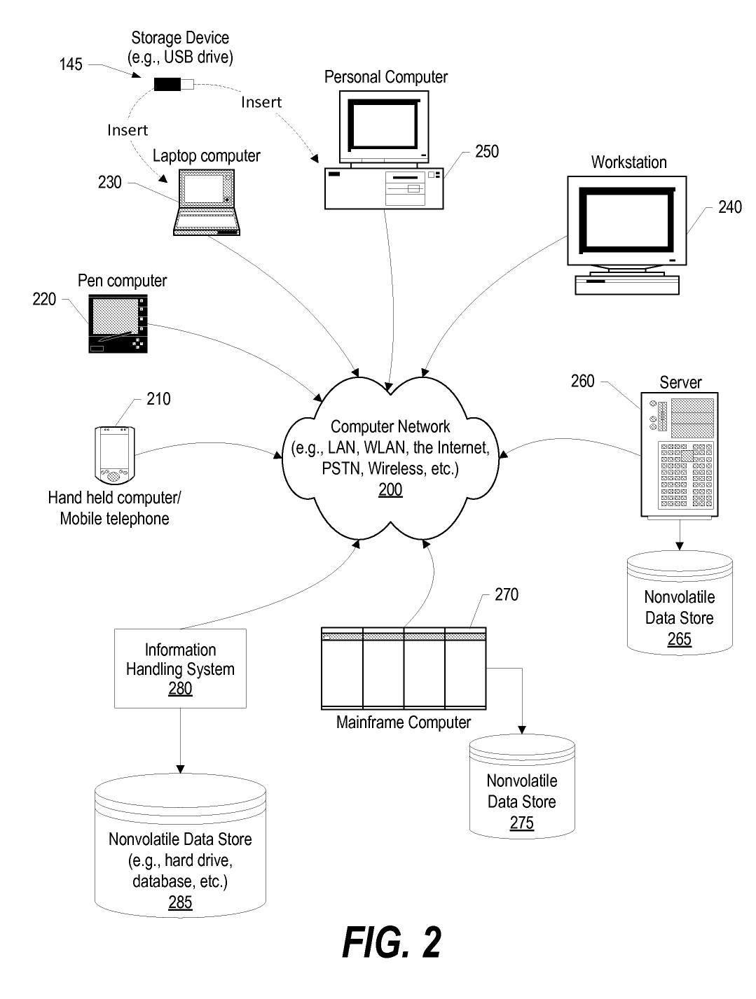

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (WLAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

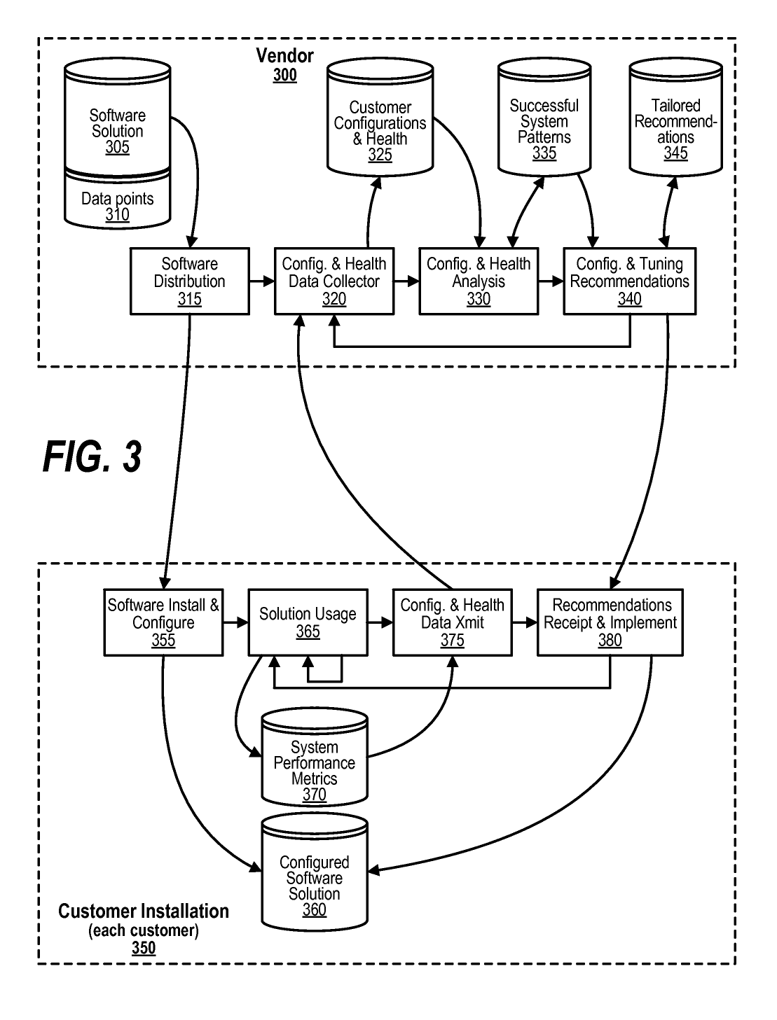

FIGS. 3-7 depict an approach that can be executed on an information handling system, to provide anonymous crowd sourced software tuning. This approach provides software that profiles the customer's installation environment, captures this information, and protects a customer's identity while sending this data up to a central source where analytics are run to identify similar environments and harvest tuning recommendations. A corresponding set of recommended tuning parameters are anonymously provided to the customer for implementation either in an automated or manual fashion. The advantages of this approach are: (1) implementations are proactively tuned based on changes and growth, therefore avoiding discovering performance problems after they are service impacting; (2) all customers leverage the experience of their peers anonymously, and (3) the approach reduces support cost for the vendor. The approach gathers statistics and configuration on a software solution environment periodically and sends them to a central location for comparison to other customers' configurations in an anonymous fashion. Analytics are run across the collection of customers to determine similar environments as well as system health based on the collected data. These results are profiled and scored configurations are synthesized to determine optimal tested configurations (based on what other customers are running) and then, based on the customers with similar environments, recommendations are identified for a particular customer and provided to the customer in an anonymous fashion. The approach can be configured based on the software solution as to how often data should be collected and evaluated from the customers. In this manner, the approach can be used as a continuous ongoing process throughout the life of the software solution.

For example, an event management system that is available 99.9%, can process up to 30 events per second and host up to 20 active users. Events are correlated and processed consistently based on rule definition. Access to the events is governed by security policy (authentication and authorization). The vendor may wish to differentiate customer systems based on the average number of events that the customers' systems usually process. For example, a “small” system might be one that, on average, manages less than 5 events per second, a medium system between 5 and 20 events per second, and a large system over 20 events per second. In this example, the vendor can analyze the data received from a customer's system and determine whether it is a “healthy” large, medium, or small system so that systems of similar classification are used to provide recommendations to unhealthy systems (e.g., recommendations to a customer of an unhealthy small system are provided by comparing system data to customers with “healthy” systems that are also small systems).

In the example event management system, the vendor may be concerned with aspects of availability, performance, functionality, and security. Availability would be identified—amongst other aspects—by the ability to receive and process events. This can be measured by a robotic client that sends sample events in a certain interval (i.e. every second), and verifies that the event is processed by the system by looking into the persistent event repository (database). Another very simplistic test would be the check of the availability of the related process name in the process list of the operating system. Performance would be identified—amongst other aspects—by the ability to process a certain amount of events. This could be measured by a robotic client that sends a set of systems events (i.e. 30 events per second) and verifies that these events are processed and not queued up in the receiver queue. Another aspect of performance would be the quantity of users. Measurement would be a simulated user performing actions through the user interface and the responsiveness of the GUI would be measured. Functionality would be defined—amongst other aspects—by the ability to correlate and process events consistently based on rule definition. Measurement would be to send a set of events into the system, and verify that these events generated the expected result (correlated event, trigger of the expected process action). Security would be defined—amongst other aspects, by the ability to govern access to the events based on security policy. It could be measured by verifying that people have access (“whitelist” testing, etc.) or by people not having access (“blacklist” testing, etc.).

The nature of the approach provided herein improves computer functionality in various ways. First, the approach provides recommendations to customers of a software product with the recommendations aimed at helping the customer improve their respective computer systems and, consequently, the functionality of such systems. Second, the approach provides anonymous reporting of data by customers which assists customers in efforts of data and computer system security so such data, if obtained by hackers or other malevolent users, cannot be used to discover and potentially exploit any security issues regarding such computer systems. Finally, the approach provides for anonymous return of recommendations that are tailored to the customers' systems despite the fact that the vendor does not know which recommendations correspond to any particular customer. Again, such anonymity serves the customers' privacy and data/computer security interests which further the computer functionality at each of the customers computer systems.

FIG. 3 is a component diagram depicting the various components used by a software vendor and its customers to implement anonymous crowd sourced software tuning. Vendor system environment 300 includes a number of data stores and processes used to provide anonymous crowd sourced software tuning of customers' systems. During software distribution process 315, then vendor transmits software product 305 to customers' systems. The software product includes data points 310 corresponding to areas in the software solution where usage data is gathered.

Customer installation 350 shows data stores and processes that are stored and performed on each customer system to enable anonymous crowd sourced software tuning. Process 355 installs and configures the software received from the vendor and the configured software solution is stored in data store 360. Subsequently, at process 365, the customer uses the software solution. During usage of the software product, usage data is stored in data store 370. Usage data also includes the customer's system data (e.g., processor quantity and types, memory, etc.) as well as configuration settings for both the software as well as the operating environment (operating system, etc.). Periodically, using process 375, the customer anonymously transmits usage data retrieved from data store 370 to the vendor to participate in crowd sourced software tuning. After the vendor has analyzed the customer's usage data, at process 380, the customer receives recommendations from the vendor regarding such things as configuration and tuning changes that the vendor recommends based on the customer's particular installation. Changes made to configuration settings and other tuning settings are reflected in a changed configured software solution stored in data store 360. This process is performed repeatedly with the customer using the software, transmitting usage data, and receiving recommendations.

Returning to vendor processing, at process 320, the vendor receives usage data that was anonymously sent to the vendor by various customers. The usage data is stored in data store 325. At step 330, the vendor performs a configuration and system health analysis using the usage data anonymously received from the customers. The analysis detects successful, or healthy, system patterns with such healthy system patterns revealing configuration and tuning settings found in healthy systems of various types (e.g., based on types of systems based on processor(s), memory, etc.). These successful system patterns are stored in data store 335. At process 340, the vendor generates recommendations tailored to the various customers that anonymously provided usage data. The recommendations, such as recommended configuration and tuning changes, are stored in data store 345. In one embodiment, a unique identifier is associated with each of the recommendations. The unique identifier, such as a hash of the usage data, being known to the customer, however such unique identifier does not identify the particular customer who anonymously sent the data. Anonymous transmission of the usage data can be performed on a computer network, such as the Internet, that interconnects the vendor's system and the customers' systems using one or more proxy servers that shield the sender (customers) identity from the recipient (software vendor).

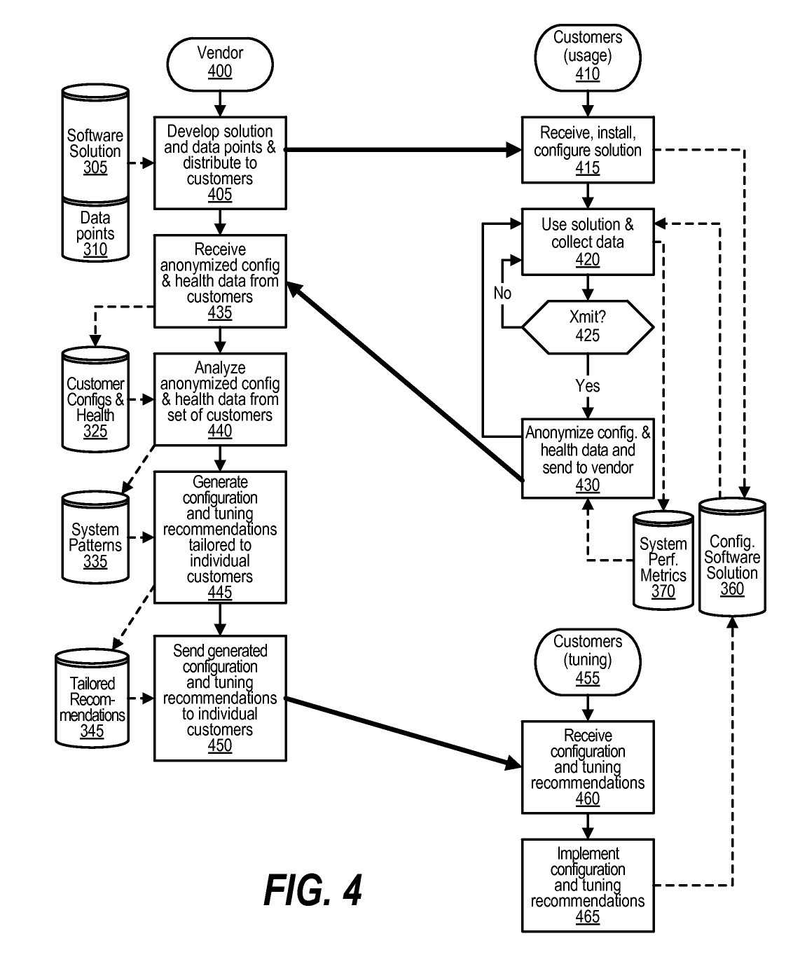

FIG. 4 is a flowchart depicting the steps performed by the vendor and customers to anonymously report the customer's usage of software and anonymously receive recommendations to tune the customers' systems. Vendor processing is shown commencing at 400 whereupon, at step 405, the vendor performs a process that develops a software solution (data store 305) and data points (data store 310) and distributes the software solution and data points to customers who purchase (license use of) the software.

Customer processing is shown commencing at 410 whereupon, at step 415, the customer performs a process to receive, install, and configure the software solution on the customer's system where it is stored as configured software solution 360. At step 420, the customer commences use of the software solution and, using the data points, the solution begins collecting usage data that is stored in data store 370. The process determines as to whether it is time to transmit the usage data to the software vendor (decision 425). For example, the usage data may be sent to the vendor on a weekly or monthly basis, etc. If it is time to transmit usage data, then decision 425 branches to the “yes” branch whereupon, at step 430, the process anonymizes the gathered configuration and usage data to remove any data that might identify the particular customer and the usage data is anonymously sent to the software vendor. Processing then loops back to step 420 to continue usage of the software. If it is not time to transmit the usage data, then decision 425 branches to the “no” branch bypassing step 430 and looping back to step 420.

Returning to vendor processing, at step 435 the vendor's system receives the anonymized usage data from customers and stores the collected usage data in data store 325. At step 440, a vendor process analyzes the anonymized usage data with the analysis resulting in system patterns corresponding to healthy systems with such healthy system patterns being stored in data store 335. At step 445, the process generates configuration and tuning recommendations that are tailored to individual customers with the generated recommendations resulting from comparing each customers' usage data (e.g., configuration settings, tuning parameters, etc.) to the corresponding usage data associated with successful system patterns that were stored in data store 335. The recommendations, tailored for individual customers, are stored in data store 345. At step 450, the process provides the generated configuration and tuning recommendations from data store 345 to individual customers. In one embodiment, the vendor provides the recommendations anonymously by storing the recommendations in a data storage area accessible to each of the customers with the customers retrieving the recommendations that correspond to the customers' particular systems.

Customer tuning process commences at 455 whereupon, at step 460, the customer's system retrieves the recommendations from the vendor (e.g., from a data storage area accessible to the customers, etc.). At step 465, the customer implements the configuration setting changes and other tuning recommendations included in the recommendations that were prepared for the customer's system. The changes to the customer's system configuration is reflected in a modified software solution that is stored in data store 360. Subsequent usage data will reflect the usage of the software solution after implementation of the recommendations by the customer.

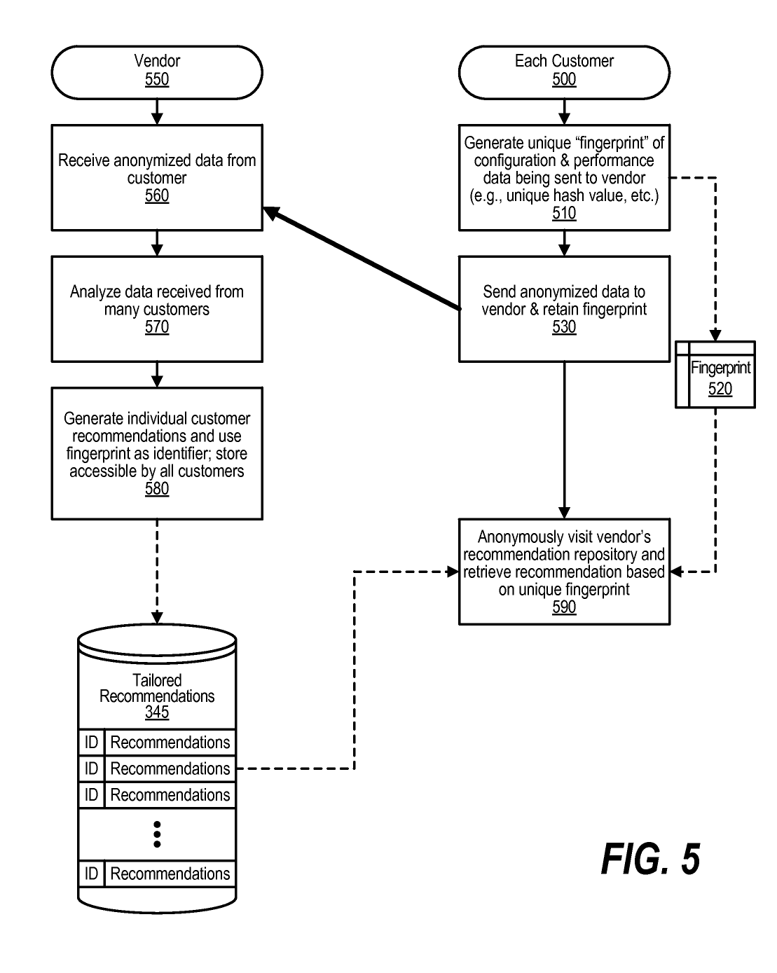

FIG. 5 is a depiction of a flowchart showing the logic performed to implement the anonymous sending of customer data to the software vendor and the customer anonymously retrieving recommendations based on customer's configuration. The process performed by each customer commences at 500 whereupon, at step 510, the customer process generates a unique “fingerprint” of the usage data that is being sent to vendor (e.g., unique hash value using a hash function on the usage data file, etc.). The fingerprint serves as a unique identifier to uniquely identify this customer's usage data from usage data from other customers and is also used in the identifier (e.g., filename, etc.) of the recommendations that the vendor will provide so that the customer can find and retrieve the recommendations prepared and tailored for the customer's system. At step 530, the customer process anonymously sends the usage data to the vendor and retains fingerprint stored in memory area 520 for future retrieval of the recommendations.

Turning to processes performed by the vendor, vendor processing commences at 550 whereupon, at step 560, the vendor process receives anonymized usage data from a customer. At step 570, the vendor process analyzes the usage data received from many such customers. At step 580, the vendor process generates individual customer recommendations and uses the unique identifier (the “fingerprint”, etc.) as the file identifier and stores the recommendations in a data storage area that is accessible by all customers (data store 345).

At step 590, the customer process anonymously visits the vendor's recommendation repository and retrieves the recommendation prepared for the customer based on the unique fingerprint. If anonymous visitation of the data storage area is not possible, then the customer can retrieve a number of recommendation files (e.g. all of the recommendations, etc.) with only one of the recommendation files being the recommendations that pertain to the customer's system. Once stored on the customer's system, the customer can discard the extra recommendations that were retrieved and retain the recommendations that were prepared that pertain to the customer's system.

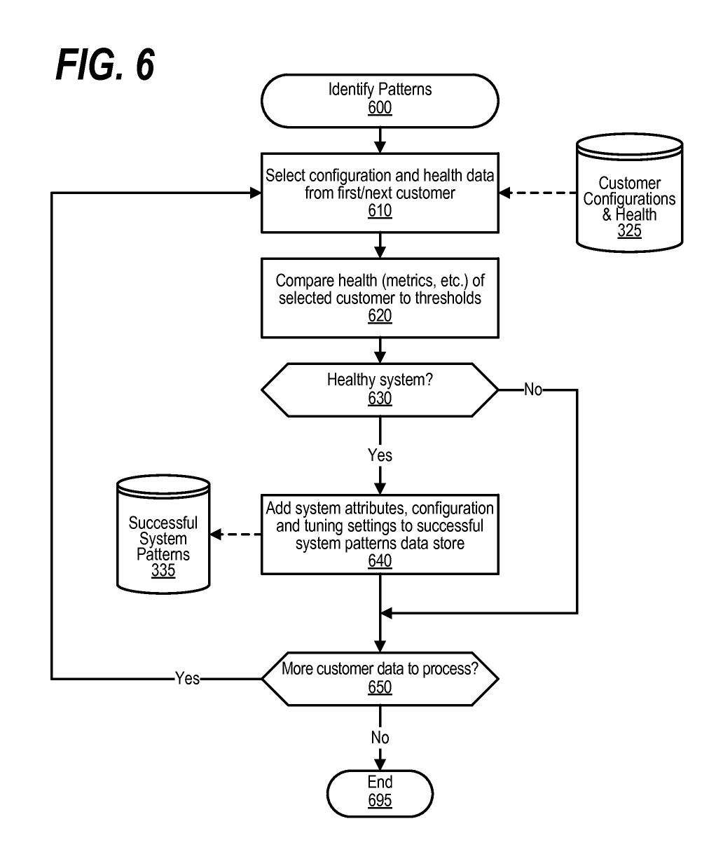

FIG. 6 is a depiction of a flowchart showing steps taken by the vendor to identify healthy and unhealthy system patterns from data anonymously received from customer systems. Processing commences at 600 whereupon, at step 610, the process selects usage data, such as configuration and system health data, from first customer. At step 620, the process compares the health data of selected customer to one or more thresholds. The process determines, based on the comparison, as to whether the selected customer's system is a healthy system (decision 630). If the selected customer's system is a healthy system, then decision 630 branches to the “yes” branch whereupon, at step 640, the process adds system attributes, configuration and tuning settings found in the usage data received from the selected customer to successful system patterns data store 335. On the other hand, if the comparison reveals that this system is not a healthy system, then decision 630 branches to the “no” branch bypassing step 640.

The process determines as to whether there are more usage data files received from other customers that need to be processed (decision 650). If there are more usage data files from other customers to process, then decision 650 branches to the “yes” branch which loops back to select and process the usage data received from the next customer. This looping continues until usage data from all of the customers has been processed, at which point decision 650 branches to the “no” branch and the processing shown in FIG. 6 ends at 695.

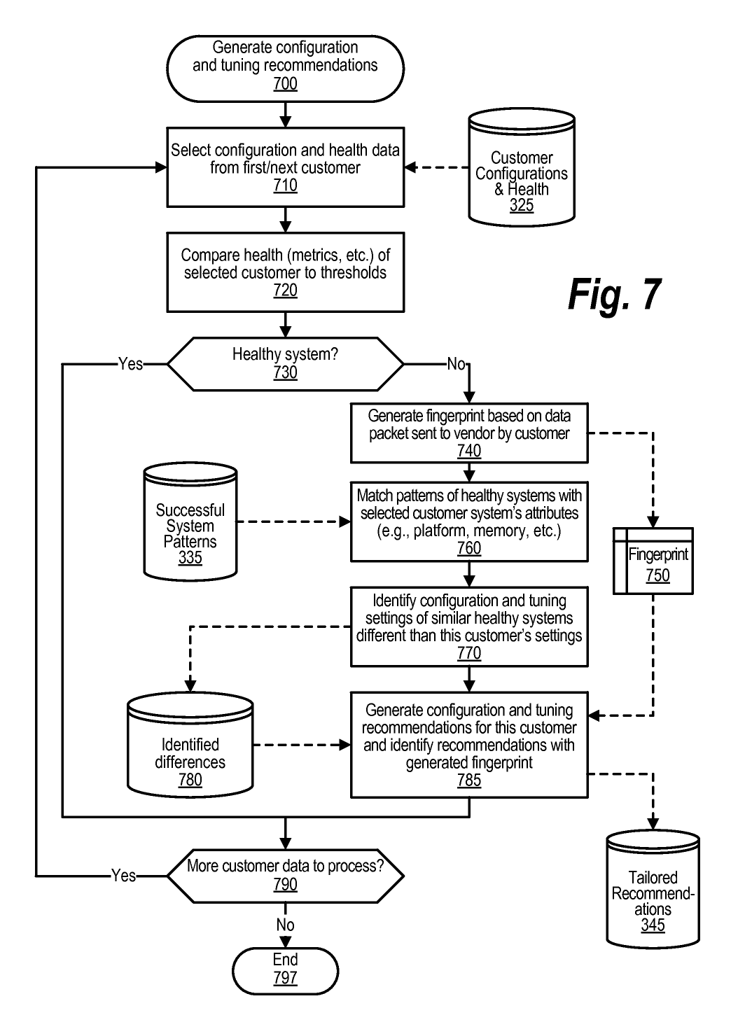

FIG. 7 is a depiction of a flowchart showing the logic performed by the software vendor to generate specific configuration and tuning recommendations for customers and allow customers with anonymous retrieval mechanism. Processing commences at 700 whereupon, at step 710, the process selects usage data from the first customer. At step 720, the process compares the health (e.g., performance metrics, etc.) of selected customer to thresholds. The process determines as to whether the selected customer system is a healthy system based on the comparison (decision 730). If the selected customer system is a healthy system, then decision 730 branches to the “yes” branch bypassing steps 740 through 785. On the other hand, if the selected customer system is not a healthy system, then decision 730 branches to the “no” branch to process the customer's usage data and prepare configuration and tuning recommendations that are tailored to this customer's system.

At step 740, the process generates a fingerprint based on data packet or file that was anonymously sent to vendor by the selected customer. The unique identifier (fingerprint) is stored in memory area 750. For example, a hash function can be executing using the usage data to generate a unique hash value that can serve as a fingerprint. At step 760, the process matches patterns of healthy systems, retrieved from data store 335, with the selected customer system's attributes (e.g., platform, memory, etc.) in order to identify healthy systems that are more similar based on attributes to the customer's system. At step 770, the process identifies the configuration and tuning settings of similar healthy systems that are different than this customer's configuration and tuning settings. The differences between the selected customer's configuration and tuning settings and similar healthy systems' configuration and tuning settings are stored in data store 780. At step 785, the process retrieves differences from data store 780 and generates a set of configuration and tuning recommendations for this customer and identifies the recommendations with generated fingerprint (e.g., associates the unique identifier of the fingerprint with the recommendations, such as in a filename, etc.). The recommendations, tailored for the selected customer's system, are stored in data store 345.

The process determines as to whether there is usage data received from other customers that need to be processed (decision 790). If there is usage data received from other customers to process, then decision 790 branches to the “yes” branch which loops back to select and process the usage data from the next customer. This looping continues until the usage data for all of the customer has been processed, at which point decision 790 branches to the “no” branch and processing ends at 795.

While particular embodiments of the present approach have been shown and described, it will be obvious to those skilled in the art that, based upon the teachings herein, that changes and modifications may be made without departing from this approach and its broader aspects. Therefore, the appended claims are to encompass within their scope all such changes and modifications as are within the true spirit and scope of this approach. Furthermore, it is to be understood that the approach is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method, in an information handling system comprising one or more processors and a memory, of anonymous crowd sourced software tuning, the method comprising:
anonymously receiving usage data from a plurality of customer systems, wherein the usage data pertains to a software product and includes at least one unique identifier generated by a selected one of the plurality of customer systems;
analyzing the received usage data, wherein the analysis identifies one or more healthy system patterns;
comparing the usage data received from each of the plurality of customer systems to at least one of the healthy system patterns;
generating a plurality of sets of one or more recommendations based on the comparison, wherein each set of recommendations corresponds to one of the plurality of customer systems;
assigning the unique identifier to a selected one set of the one or more recommendations that correspond to the selected customer system; and
providing the selected set of the one or more recommendations to the selected customer system, wherein the selected customer system is adapted to identify the selected set of the one or more recommendations based upon the unique identifier.

2. The method of claim 1 further comprising:
identifying a healthy system configuration associated with each of the one or more healthy system patterns;
comparing a system configuration associated with each of the plurality of customer systems with the identified healthy system configurations, the comparing resulting in a selected one of the healthy system configurations and a corresponding selected healthy system pattern; and
wherein the comparing of the usage data received from each of the plurality of customer systems is compared to the selected healthy system pattern of the healthy system configuration found to be similar to a customer system configuration corresponding to one of the plurality of customer systems.

3. The method of claim 2 further comprising:
comparing one or more configuration settings in the customer system configuration to corresponding configuration settings in the selected healthy system configuration, wherein the comparing of configuration settings results in one or more configuration setting changes included in the generated recommendations.

4. The method of claim 3 further comprising:
comparing customer system health data included in the usage data received from each of the plurality of customer systems to one or more thresholds; and
identifying a selected set of one or more healthy systems in response to the comparison of the customer system health data to the thresholds revealing that at least one of the plurality of customer systems are healthy,
wherein the healthy configurations and healthy system patterns correspond to the identified healthy systems.

5. The method of claim 4 further comprising:
identifying a selected set of one or more unhealthy systems in response to the comparison of the customer system health data to the thresholds revealing that at least one of the plurality of customer systems are unhealthy, wherein the customer configurations correspond to the unhealthy systems.

6. (canceled)

7. The method of claim 1 wherein the generation of the unique identifier is performed by the selected customer system by executing a hash function against the usage data, wherein the unique identifier is retained by the customer system before reception of the usage data.

8. An information handling system comprising:
one or more processors;
a memory coupled to at least one of the processors;
a network adapter that connects the information handling system to a computer network; and
a set of instructions stored in the memory and executed by at least one of the processors to provide anonymous crowd sourced software tuning, wherein the set of instructions perform actions of:
anonymously receiving usage data from a plurality of customer systems, wherein the usage data pertains to a software product and includes at least one unique identifier generated by a selected one of the plurality of customer systems;
analyzing the received usage data, wherein the analysis identifies one or more healthy system patterns;
comparing the usage data received from each of the plurality of customer systems to at least one of the healthy system patterns;
generating a plurality of sets of one or more recommendations based on the comparison, wherein each set of recommendations corresponds to one of the plurality of customer systems;
assigning the unique identifier to a selected one set of the one or more recommendations that correspond to the selected customer system; and
providing the selected set of the one or more recommendations to the selected customer system, wherein the selected customer system is adapted to identify the selected set of the one or more recommendations based upon the unique identifier.

9. The information handling system of claim 8 wherein the actions further comprise:
identifying a healthy system configuration associated with each of the one or more healthy system patterns;
comparing a system configuration associated with each of the plurality of customer systems with the identified healthy system configurations, the comparing resulting in a selected one of the healthy system configurations and a corresponding selected healthy system pattern; and
wherein the comparing of the usage data received from each of the plurality of customer systems is compared to the selected healthy system pattern of the healthy system configuration found to be similar to a customer system configuration corresponding to one of the plurality of customer systems.

10. The information handling system of claim 9 wherein the actions further comprise:
comparing one or more configuration settings in the customer system configuration to corresponding configuration settings in the selected healthy system configuration, wherein the comparing of configuration settings results in one or more configuration setting changes included in the generated recommendations.

11. The information handling system of claim 10 wherein the actions further comprise:
comparing customer system health data included in the usage data received from each of the plurality of customer systems to one or more thresholds; and
identifying a selected set of one or more healthy systems in response to the comparison of the customer system health data to the thresholds revealing that at least one of the plurality of customer systems are healthy, wherein the healthy configurations and healthy system patterns correspond to the identified healthy systems.

12. The information handling system of claim 11 wherein the actions further comprise:
identifying a selected set of one or more unhealthy systems in response to the comparison of the customer system health data to the thresholds revealing that at least one of the plurality of customer systems are unhealthy, wherein the customer configurations correspond to the unhealthy systems.

13. (canceled)

14. The information handling system of claim 8 wherein the generation of the unique identifier is performed by the selected customer system by executing a hash function against the usage data, wherein the unique identifier is retained by the customer system before reception of the usage data.

15. A computer program product stored in a computer readable storage medium, comprising computer instructions that, when executed by an information handling system, causes the information handling system to provide anonymous crowd sourced software tuning by performing actions comprising:
anonymously receiving usage data from a plurality of customer systems, wherein the usage data pertains to a software product and includes at least one unique identifier generated by a selected one of the plurality of customer systems;
analyzing the received usage data, wherein the analysis identifies one or more healthy system patterns;
comparing the usage data received from each of the plurality of customer systems to at least one of the healthy system patterns;
generating a plurality of sets of one or more recommendations based on the comparison, wherein each set of recommendations corresponds to one of the plurality of customer systems;
assigning the unique identifier to a selected one set of the one or more recommendations that correspond to the selected customer system; and
providing the selected set of the one or more recommendations to the selected customer system, wherein the selected customer system is adapted to identify the selected set of the one or more recommendations based upon the unique identifier.

16. The computer program product of claim 15 wherein the actions further comprise:
identifying a healthy system configuration associated with each of the one or more healthy system patterns;
comparing a system configuration associated with each of the plurality of customer systems with the identified healthy system configurations, the comparing resulting in a selected one of the healthy system configurations and a corresponding selected healthy system pattern; and
wherein the comparing of the usage data received from each of the plurality of customer systems is compared to the selected healthy system pattern of the healthy system configuration found to be similar to a customer system configuration corresponding to one of the plurality of customer systems.

17. The computer program product of claim 16 wherein the actions further comprise:
comparing one or more configuration settings in the customer system configuration to corresponding configuration settings in the selected healthy system configuration, wherein the comparing of configuration settings results in one or more configuration setting changes included in the generated recommendations.

18. The computer program product of claim 17 wherein the actions further comprise:
comparing customer system health data included in the usage data received from each of the plurality of customer systems to one or more thresholds; and
identifying a selected set of one or more healthy systems in response to the comparison of the customer system health data to the thresholds revealing that at least one of the plurality of customer systems are healthy, wherein the healthy configurations and healthy system patterns correspond to the identified healthy systems; and
identifying a selected set of one or more unhealthy systems in response to the comparison of the customer system health data to the thresholds revealing that at least one of the plurality of customer systems are unhealthy, wherein the customer configurations correspond to the unhealthy systems.

19. (canceled)

20. The computer program product of claim 15 wherein the generation of the unique identifier is performed by the selected customer system by executing a hash function against the usage data, wherein the unique identifier is retained by the customer system before reception of the usage data.
